(19) United States
(12) Patent Application Publication
(10) Pub. No.: US 2023/0352707 A1
(43) Pub. Date: Nov. 2, 2023

(54) RECIRCULATION BLOWER

(71) Applicant: BorgWarner Inc., Auburn Hills, MI (US)

(72) Inventor: Mathias Kosch, Mainz (DE)

(21) Appl. No.: 17/828,596

(22) Filed: May 31, 2022

(30) Foreign Application Priority Data
Apr. 29, 2022 (DE) DE102022110555.5

(51) Int. Cl. H01M 8/04089; H02K 3/44; H02K 11/33; H02K 21/24; F04D 17/10; F04D 29/28; F04D 29/44

(52) U.S. Cl. CPC H01M 8/04097; H02K 3/44; H02K 11/33; H02K 21/24; F04D 17/10; F04D 29/281; F04D 29/444

(57) ABSTRACT

A recirculation blower (17) for hydrogen recirculation in a fuel cell system is configured as an axial blower. The recirculation blower (17) includes a housing (27) having a gas inlet (23) and a gas outlet (25) and having an electric motor (29), which is arranged in the interior of the housing (27), and includes a stator unit (31) and a rotor (33) having at least one impeller (41). A flow path runs outside the stator unit (31) from the gas inlet (23) to the gas outlet (25).

### CROSS-REFERENCE TO RELATED APPLICATIONS

This application claims priority pursuant to 35 U.S.C. 119(a) to German Patent Application No. 102022110555.5 filed Apr. 29, 2022, which application is incorporated herein by reference in its entirety.

### BACKGROUND

The invention relates to a recirculation blower for hydrogen recirculation in a fuel cell system.

A fuel cell system can be provided in a vehicle, a train, an aircraft or a ship. Electrical energy is generated in the fuel cell system, for example by hydrogen, in order to produce drive.

In addition to a fuel cell unit, which is supplied with gaseous hydrogen, the fuel cell system can have a return for unused hydrogen gas to the inlet of the fuel cell unit. A recirculation blower is provided in the return in order to return the unused hydrogen gas to the inlet and to ventilate the fuel cell. It is thereby possible to achieve lower fuel consumption.

The recirculation blower can be designed as an electrically operated compressor, for example a radial compressor. Side-channel compressors and rotary piston blowers, referred to as Roots blowers, with a relatively low target pressure ratio are also used.

### SUMMARY

It is the object of the invention to provide an alternative recirculation blower.

The object is achieved by means of a recirculation blower for hydrogen recirculation in a fuel cell system having the features of claim 1.

The recirculation blower is designed as an axial blower and comprises: a housing having a gas inlet and a gas outlet and having an electric motor, which is arranged in the interior of the housing and comprises a stator unit and a rotor having at least one impeller, wherein a flow path runs outside the stator unit from the gas inlet to the gas outlet.

The recirculation blower is a compact modular, self-sealing axial blower, which can also be referred to as an axial machine, having external control electronics, as a hydrogen recirculation blower. The axial blower as a recirculation blower can have a symmetrical, cylindrical basic shape which resembles a tube.

The recirculation blower returns hydrogen which has not been consumed during the reaction in a fuel cell to the fuel cell of the fuel cell system, and this reduces hydrogen consumption and aging of the fuel cell. The recirculation blower is designed as an axial blower which advantageously also acts as a compressor. By means of the electric motor, the rotor is driven together with the impeller, and, as a result, gas is sucked in through the gas inlet and ejected at the gas outlet. The flow path from the gas inlet to the gas outlet runs outside the stator unit, and therefore the gas flows past the stator unit on the outside. The gas flows between the housing and the stator unit along the rotor and in the process through the blade of the impeller. During this process, the gas is compressed in order to maintain the direction of flow of the hydrogen to the inlet of the fuel cell. The gas is sucked in and ejected in the axial direction. The axial direction runs along the axis of rotation of the rotor.

The rotor comprises rotating components of the recirculation blower, in particular a shaft and at least one impeller. The stator unit comprises stationary, non-rotating components. Both the rotor and the stator unit have magnetically acting regions, the interaction of which causes the rotor to rotate. In one embodiment, the stator unit comprises windings through which current flows, in which, as a function of a time-variable current flowing through the windings, a time-variable magnetic field is induced which, with a permanent-magnetic region as the magnetically acting region of the rotor, brings about a rotation of the rotor.

The stator unit is additionally designed to hold at least an end region of the rotor. For this purpose, bearings are provided for the rotor. The stator unit can be designed as a block, into which one of the end regions of the rotor projects and is driven in this end region. Alternatively, the stator unit can comprise two sub-blocks with magnetically acting regions, into each of which one of the end regions of the rotor projects, thus being held and driven at both ends by the sub-blocks.

The electric motor is arranged in the flow path of the gas. The gas flows around the electric motor on its path between the gas inlet and the gas outlet and in the process flows through the blades of the impeller. The electric motor is arranged in a central region of the housing, with the result that gas flowing in through the inlet flows onto the stator unit, which faces the gas inlet, and is deflected by the stator unit around the outside of the electric motor. As a result, the gas flows between the housing and the electric motor, substantially parallel to the axis of rotation thereof, through the housing to the outlet. Blades of the impeller project into the flow path of the gas.

The axial blower as a recirculation blower requires less space than a radial blower as a recirculation blower. Such an axial blower as a recirculation blower with integrated electric drive can be used in various fuel cell systems.

In one embodiment, a first section of the rotor engages in the stator unit, and a second section of the rotor with the impeller is arranged outside the stator unit. In such an embodiment, the stator unit can be designed as a single drive block, the magnetically acting region of which interacts with the magnetically acting region on the first section of the rotor, with the result that the rotor is driven only in one end region and the other end region is advantageously rotatably supported in a bearing receptacle by means of a bearing.

In an alternative embodiment, the stator unit comprises two sub-blocks, spaced apart from one another, with magnetically acting regions, one of the end regions of the rotor projecting into each sub-block. In this embodiment, the drive takes place at both ends of the rotor. The end regions are first sections of the rotor in which the drive takes place, and the second section of the rotor with the impeller runs between the sub-blocks outside the sub-blocks.

In one embodiment, an end face of the second section of the rotor, the end face facing the stator unit, is designed to direct gas which has flowed in between the end face and the electric motor block to the outside. Such an end face, which can also be referred to as rotor hub end face, is a radial widening of the shaft, which can be formed integrally with the shaft, or is a separate component connected to the shaft. Such an end face advantageously has a blade structure in which raised portions running in an arc project in the axial direction on the end face. As a result, the end face has the shape and function of a spiral pump for conveying penetrating hydrogen back into the main flow.

One embodiment of the recirculation blower comprises a hydrogen barrier with a hydrogen-absorbing material, which is arranged on a side of the stator unit from which the rotor projects. The hydrogen barrier is advantageously arranged between the magnetically acting regions of the stator unit and rotor and the end face of the rotor. The hydrogen barrier faces the end face for discharging the gas, thus constituting an additional protective measure against the penetration of hydrogen. It absorbs hydrogen which could otherwise possibly penetrate as far as the magnetically acting regions. A hydrogen-absorbing material can be a metal hydride.

The hydrogen barrier with hydrogen-absorbing material and the end face with a blade structure which acts like a spiral pump are two means for preventing or at least hindering the penetration of hydrogen into the magnetically acting regions. The two means can be used individually or in combination with one another.

In one embodiment, the second section of the rotor is designed in such a way that it has an impeller mount on which a variable number of impellers, in particular up to two impellers, can be mounted. The rotor is configured in such a way, for example, that, when the recirculation blower is being assembled, either just one impeller or two impellers are mounted on the impeller mount. In this way, a rotor with one or two impellers can be assembled from the same components without the need for structural changes. In a recirculation blower with two adjacent impellers, a guide vane system with guide vanes is also arranged between them, which is not necessary with just one impeller. A guide vane system is a fixed radial vane system which influences the swirl of the gas flowing between the impellers.

The above-described modular approach for the impellers and guide vanes makes it possible to adapt to different pressure conditions for the compression of the recirculation blower. Different compressor stages, optionally with different numbers of impellers, are provided for different desired pressure ratios between the outlet pressure and the inlet pressure. The modular approach makes it possible to build multi-stage blowers for higher pressure ratios. In the case of a modular, single-stage or, when required, two-stage axial machine with impellers arranged on the inside, a variable pressure ratio of up to approximately 2.0 can be achieved by means of the two-stage arrangement, for example. The modular approach also offers potential for cost savings and a reduction in effort. Moreover, it is thereby possible to save energy since efficiency as a compressor is improved.

In order to position the stator unit in the interior of the housing, it is held by at least one set of webs which run radially from the housing to the stator unit. The gas can flow past the outside of the stator unit between the webs. It is advantageous if guide vanes are arranged on the webs or the webs are designed as guide vanes in order to influence the flow behavior of the gas. The webs are used to position and supply power to the electric motor in the turbomachine, connecting the motor to the tubular housing, which is, for example, circular.

To control the stator unit, a control circuit is provided, as well as a power supply, running through the webs, for the stator unit, with the result that current flows through the windings in the coils. The control circuit is arranged on the outside of the housing and can have a cooling system. The power supply and power electronics as the control circuit outside the housing can be designed, for example, as a molded-on solution or can be arranged in a further housing.

### BRIEF DESCRIPTION OF THE DRAWINGS

Some exemplary embodiments are explained in greater detail below with reference to the drawing. In the drawing:

FIG. 1 shows schematically an exemplary embodiment of a fuel cell system;

FIG. 2 shows a schematic sectional illustration through one embodiment of a recirculation blower;

FIG. 3 shows a plan view of a disk, the front side of which is an exemplary embodiment of an end face; and

FIG. 4 shows a schematic sectional illustration through another exemplary embodiment of a recirculation blower.

In the figures, identical or functionally identical elements are provided with the same reference signs.

### DETAILED DESCRIPTION

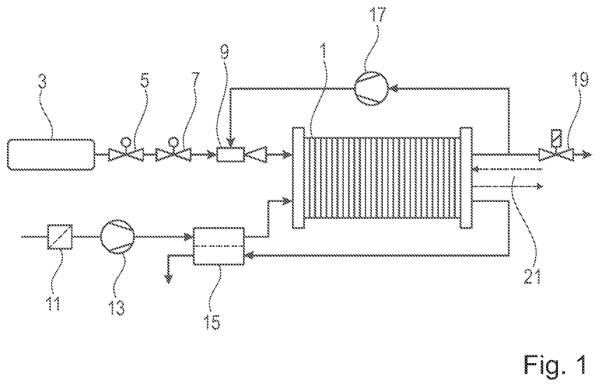

FIG. 1 shows schematically an exemplary embodiment of a fuel cell system having a fuel cell unit 1, which comprises a stack having a plurality of fuel cells. The fuel cells each have an anode and a cathode as well as a membrane arranged between them. On the anode side, a fuel, in this exemplary embodiment gaseous hydrogen, is fed in. The feed takes place from a hydrogen reservoir 3 designed as a tank via a pressure reducer 5 and a pressure control valve 7 connected downstream of the pressure reducer 5. Hydrogen from the pressure-reducing valve 7 and hydrogen recirculated from the fuel cell unit 1 are fed to the fuel cell unit 1 on the anode side via an ejector 9. On the cathode side, an oxidizing agent, usually air, is fed in. The feed takes place via a filter 11 and an air compressor 13. The compressed air passes through an air humidifier 15 in order to improve efficiency and is fed to the fuel cell unit 1 on the cathode side.

The fuel and the oxidizing agent react in the interior of the fuel cells and release energy while simultaneously generating water. However, hydrogen which flows from the hydrogen reservoir 3 into the anode side is usually not completely converted into water. Nitrogen and water, which are formed in the anode during the reaction and would increasingly impair efficiency, are discharged from the fuel cell unit 1 in order to create space for hydrogen. This makes possible an efficient reaction and does not damage the sensitive membrane in the fuel cells, so that the fuel cell system 1 functions well even in the cold and has a long service life. Because of the aforementioned points, a recirculation circuit with a recirculation blower 17 in the hydrogen return and a drain valve 19 at the anode are provided. On the one hand, the recirculation circuit feeds the unused hydrogen back into the anode inlet and, on the other hand, discharges the nitrogen and the excess water through the drain valve 19. The water is fed to the air humidifier 15 in order to humidify the inlet air. The recirculation blower 17 for recirculating the hydrogen can be formed in an integrated manner on the anode side of the fuel cell stack.

Cooling connections 21 of the fuel cell unit 1 are connected to a cooling system in order to cool the fuel cell unit 1.

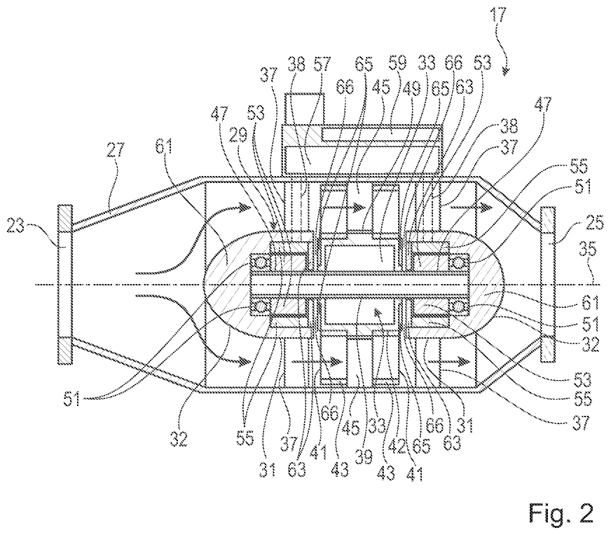

FIG. 2 shows a schematic sectional illustration through one exemplary embodiment of a recirculation blower 17. Such a recirculation blower 17 for hydrogen can be a component of a fuel cell system, as described by way of example in connection with FIG. 1.

The recirculation blower 17 is designed as an axial blower. It comprises a gas inlet 23 and a gas outlet 25 in a housing 27, through which gas flows along a flow path from the gas inlet 23 to the gas outlet 25. The gas flows into and out of the recirculation blower 17 in the axial direction. Within the housing 27, the gas flows in the axial direction past an electric motor 29, undergoing a deflection radially outward and then inward again in the end regions thereof. The flow path of the gas is illustrated by arrows. The gas for ventilation of a fuel cell unit mainly comprises hydrogen, but also nitrogen and steam.

The electric motor 29 is arranged in a central region in the housing 27 and comprises a stator unit 31 with two sub-blocks 32 spatially separated from one another, and a rotor 33. The sub-blocks 32 and hence the electric motor 29 are connected to the housing 27 via a plurality of webs 37. The webs 37 extend radially between the housing 27 and the sub-blocks 32, thus enabling the gas to flow through between the webs 37 outside the electric motor 29. For each of the sub- blocks 32, three webs 37 are provided, for example, which are arranged at a spacing of 120 degrees. The webs 37 are designed as guide vanes in order to influence the flow behavior of the gas.

The rotor 33 comprises rotating components of the recirculation blower 17, in particular a rotatable shaft 39 and at least one impeller 41 arranged thereon, with blades 43 extending radially with respect to the axis of rotation. In this exemplary embodiment, a first and a second impeller 41 are provided, which are connected to the shaft 39 for conjoint rotation therewith. The impellers 41 can be mounted on an impeller mount 42 for a plurality of impellers 41 and are spaced apart axially. The impeller mount 42 is the region of the rotor 33 onto which the impellers 41 can be mounted. This can be a radially widened region, as in this exemplary embodiment. A guide vane system 45 is provided between the impellers 41, which guide vane system is secured on the housing 27 and does not rotate.

The shaft 39 is designed in such a way that either one or two impellers 41 can be mounted on it. This results in a degree of freedom in the assembly of the recirculation blower 17. Thus, the modular recirculation blower 17 can be adapted in a simple manner to the requirements in use during assembly, in that either just one impeller 41 or two impellers 41 with guide vane systems 43 are mounted without the need for complex re-design.

The rotor 33 comprises at least a first section 47 and a second section 49. The first section 47 projects into the stator unit 31, and the second section 49 is arranged outside the stator unit 31. In this exemplary embodiment, the end regions of the rotor 33 which project into the two sub-blocks 32 are the first sections 47, and the second section 49 runs between the sub-blocks 32. In the sub-blocks 32, bearings 51, designed for example as ball bearings, are provided at the ends of the rotor 33 in order to hold the rotor 33 rotatably in its position. Ball bearings are particularly suitable and have virtually no limitations with respect to their usability. The first sections 47 of the rotor 33 furthermore comprise rotatable magnetically acting regions 53, which are arranged on the shaft 39 for conjoint rotation therewith. Stationary magnetically acting regions 55 are arranged in the sub-blocks 32 around the rotatable magnetically acting regions 53. Permanent magnets are arranged on the shaft 39 as magnetically acting regions 53. Around these there run windings in coils as magnetically acting regions 55 of the stator unit 31, in which a time-variable magnetic field can be induced by time-variable current flow. The interaction of the magnetic fields of the magnetically acting regions 53, 55 causes the rotor 33 to rotate.

A control circuit 57 for the electric motor 29, which controls the current flow through the windings, is arranged on the outside of the housing 27. A cooling system 59 is provided on the control circuit 57. Depending on the power consumption of the electric motor 29 and the currents in the windings, such a cooling system 59 is not necessary in some exemplary embodiments. The control circuit 57 can be provided, for example, as power electronics for approximately 1.5 kW as an external circuit. The electric motor 29 is supplied by supply lines 38, which run along or in the webs 37.

The windings of the magnetically acting regions 55 and bearings 51 in the sub-blocks 32 of the stator unit 31 are jacketed or encapsulated, with the result that the gas flow is directed laterally around the stator unit 32. The jackets 61 of the sub-blocks 32 are dome-shaped and the apexes thereof face the gas inlet 23 or the gas outlet 25. The jackets 61 can be designed as potting. The jackets 61 form a split design of a flow body in order to direct the flow path of the gas between the housing 27 and the electric motor 29.

On the sides of the sub-blocks 32 from which the rotor 33 projects and which face its second section 49, a hydrogen barrier 63 is provided, which surrounds the rotor 33 in the radial direction and is arranged over an extended area between the rotor 33 and magnetically acting regions 53, 55 in the interior of the stator unit 31. The hydrogen barrier 63 is part of the stator unit 31 and comprises hydrogen-absorbing material, for example metal hydride. In this way, penetration of the hydrogen into the stator unit 31 and, in particular, into the magnetically acting regions 53, 55 is prevented.

The second section 49 of the rotor 33 comprises the first and second impellers 41, which are mounted on the shaft 39. The shaft 39 is widened radially in order to avoid turbulence of the gas flowing axially along at the transition between the sub-blocks 32 of the stator unit 31 and the second section 49 of the rotor 33.

On the second section 49, facing the sub-blocks 32, there are radially extending round end faces 65, which are designed in such a way that they divert to the outside gas that has flowed in between the end faces 65 and the sub-blocks 32. In this way, gas which penetrates into the gaps 66 between the end faces 65 and the hydrogen barriers 63 is not only prevented from penetrating into the interior of the stator unit 31 by the hydrogen barriers 63, but ideally is already conveyed back out of the gap 66 in advance. The end face 65 has a blade structure, the rotation of which forces the gas between the gaps 66 outwards into the axially extending flow path along the axis of rotation 35.

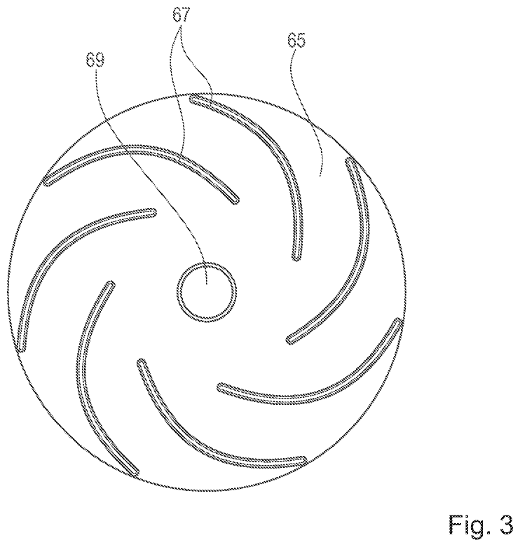

FIG. 3 shows a plan view of a disk, the front side of which forms the end face 65 of the second section 49 of the rotor 33. The disk has a frustoconical basic shape, and therefore the end face 65 is inclined at an obtuse angle to the axial direction, the course of which corresponds to that of the axis of rotation 35. Alternatively, it can also run perpendicularly to the axial direction.

Raised portions running in an arc from the inside to the outside project in the axial direction on the end face 65 and form the blade structure 67 for discharging the gas to the outside when the end face 65 is rotating. The blade structure 67 acts like a spiral pump. The disk has a hole 69 in the center through which the shaft 39 extends. Alternatively, the end face 65 can also be designed as a radially widened region of a shaft 39, being formed integrally with the latter.

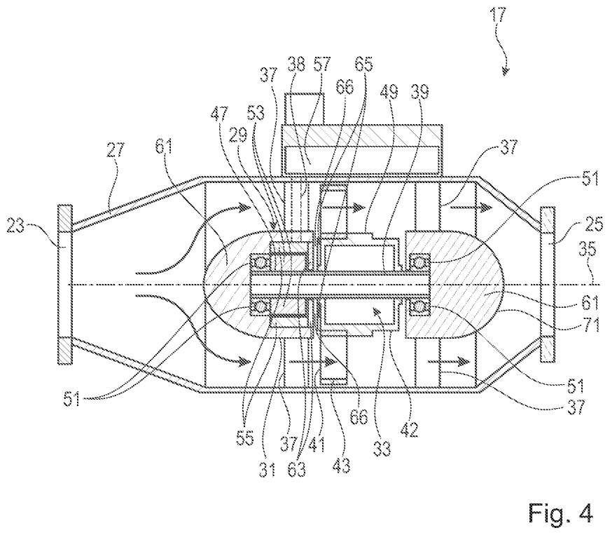

FIG. 4 shows a schematic sectional illustration through another exemplary embodiment of a recirculation blower 17. To avoid repetition, the following description concentrates on differences from the preceding exemplary embodiment, which has been described in conjunction with FIGS. 2 and 3.

In the exemplary embodiment in FIG. 4, the stator unit 31 comprises only one block, and therefore the rotor 33 is driven only in one of its end regions. The other end region is held by a bearing receptacle 71. Both the stator unit 31 and the bearing receptacle 71 are held by webs 37. The webs 37 extend radially between the housing 27 and the stator unit 31 or the bearing receptacle 71, thus enabling the gas to flow through between the webs 37.

The rotor 33 comprises an end region as the first section 47, which projects into the stator unit 31, and a second section 49, which runs between the stator unit 31 and the bearing receptacle 71. The other end region projects into the bearing receptacle 71. In the stator unit 31 and the bearing receptacle 71, bearings 51, designed for example as ball bearings, are provided at the ends of the rotor 33 in order to hold the rotor 33 rotatably in its position. The first section 47 of the rotor 33 in the stator unit 31 furthermore comprises a rotatable magnetically acting region 53, which is arranged on the shaft 39 for conjoint rotation therewith. A stationary magnetically acting region 55 is arranged in the stator unit 31 around the rotatable magnetically acting region 53.

Both the stator unit 31 and the bearing receptacle 71 have a jacket, with the result that the gas flow is directed laterally around the stator unit 31 and the bearing receptacle 71. The jackets 61 are dome-shaped and the apexes thereof face the gas inlet 23 or the gas outlet 25. The jackets 61 can be designed as potting.

The shaft 39 is designed in such a way that either one or two impellers 41 can be mounted on one impeller mount 42. The impeller mount 42 is located in the widened region of the second section 49 of the rotor 33. However, in this exemplary embodiment, only one impeller 41 is mounted and, in the absence of a further impeller 41, no guide vane system 43 is provided.

Since no magnetically acting regions which would have to be protected against the penetration of hydrogen are provided in the bearing receptacle 71, neither a hydrogen barrier 63 is provided on the bearing receptacle 71 nor an end face 65 with a blade structure 67 is provided on the side of the second section 49 facing the bearing receptacle 71. The bearing receptacle 71 and the stator unit 31 can be designed in such a way that the same rotor 33, either with one or two impellers 41, can be installed in such a combination of bearing receptacle 71 and stator unit 31, as described, or in a stator unit 31 with two sub-blocks 32.

Because of the stator unit 31 provided in only one end region and the presence of just one impeller 41, the recirculation blower 17 is designed for lower outputs than the preceding exemplary embodiment. The provision of the stator unit 31 as just one block in one of the end regions is expedient for an electric motor 29 with a lower power requirement since it is associated with a less expensive recirculation blower 17. For this reason, no cooling system 59 is provided on the control circuit 57 either. By providing one or two impellers 41 and/or a suitable selection of different impellers 41, a further adaptation to the power range can be carried out, this taking place only during assembly. In this way, production can be adapted flexibly and easily to changing requirements without adaptations in the design being necessary.

The features indicated above and in the claims and those which can be gathered from the figures can be implemented in an advantageous way, both individually and in various combinations. The invention is not restricted to the exemplary embodiments described but can be modified in a variety of ways within the capabilities of a person skilled in the art.

### REFERENCE SIGNS

1 fuel cell unit
3 hydrogen reservoir
5 pressure reducer
7 pressure control valve
9 ejector
11 filter
13 air compressor
15 air humidifier
17 hydrogen recirculation blower
19 drain valve
21 cooling connection
23 gas inlet
25 gas outlet
27 housing
29 electric motor
31 stator unit
32 sub-block
33 rotor
35 axis of rotation
37 web
38 supply line
39 shaft
41 impeller
42 impeller mount
43 blades
45 guide vane system
47 first section
49 second section
51 bearing
53 magnetically acting region
55 magnetically acting region
57 control circuit
59 cooling system
61 jacket
63 hydrogen barrier
65 end face
66 gap
67 blade structure
69 hole
71 bearing receptacle

What is claimed is:

1. A recirculation blower for hydrogen recirculation in a fuel cell system, wherein the recirculation blower is configured as an axial blower and comprises:
a housing having a gas inlet and a gas outlet and having an electric motor, which is arranged in the interior of the housing and comprises a stator unit and a rotor having at least one impeller, wherein a flow path runs outside the stator unit from the gas inlet to the gas outlet.

2. The recirculation blower as claimed in claim 1,
wherein a first section of the rotor engages in the stator unit, and a second section of the rotor with the impeller, whose blades project into the flow path, is arranged outside the stator unit.

3. The recirculation blower as claimed in claim 1,
wherein the stator unit comprises two sub-blocks spaced apart from one another, and one of the end regions of the rotor projects into each sub-block.

4. The recirculation blower as claimed in claim 3,
wherein the end regions are first sections of the rotor, and the second section of the rotor is arranged outside the sub-blocks and between the sub-blocks.

5. The recirculation blower as claimed in claim 1,
wherein an end face of the second section of the rotor, the face facing the stator unit, is configured to direct gas which has flowed in between the end face and the stator unit to the outside.

6. The recirculation blower as claimed in claim 5,
wherein the end face has a blade structure.

7. The recirculation blower as claimed in claim 5,
comprising a hydrogen barrier with a hydrogen-absorbing material, which is arranged on a side of the stator unit from which the rotor projects.

8. The recirculation blower as claimed in claim 7,
wherein the hydrogen barrier is arranged between a magnetically acting region in the stator unit and the end face.

9. The recirculation blower as claimed in claim 7,
wherein the hydrogen-absorbing material comprises a metal hydride.

10. The recirculation blower as claimed in claim 1,
wherein the rotor is configured with an impeller mount such that a variable number of impellers can be mounted on the impeller mount.

11. The recirculation blower as claimed in claim 1,
wherein a guide vane system is arranged between two adjacent impellers.

12. The recirculation blower as claimed in claim 1,
wherein the stator unit is held by webs which run radially between the housing and the stator unit.

13. The recirculation blower as claimed in claim 12,
wherein guide vanes are arranged on the webs or the webs are guide vanes.

14. The recirculation blower as claimed in claim 12,
comprising a control circuit for the electric motor and a power supply, running through the webs, for the stator unit.

15. The recirculation blower as claimed in claim 2,
wherein the stator unit comprises two sub-blocks spaced apart from one another, and one of the end regions of the rotor projects into each sub-block.

16. The recirculation blower as claimed in claim 15,
wherein the end regions are first sections of the rotor, and the second section of the rotor is arranged outside the sub-blocks and between the sub-blocks.

17. The recirculation blower as claimed in claim 1,
comprising a hydrogen barrier with a hydrogen-absorbing material, which is arranged on a side of the stator unit from which the rotor projects.
